(19) United States
(12) Patent Application Publication
(10) Pub. No.: US 2025/0272100 A1
(43) Pub. Date: Aug. 28, 2025

(54) METHOD FOR MINIMIZING MEMORY TRAFFIC DELAY WHEN EXECUTING ARTIFICIAL INTELLIGENCE MODEL AND COMPUTER SYSTEM PERFORMING THEREOF

(71) Applicant: NeublaKorea Corporation, Seoul (KR)

(72) Inventors: Minwook AHN, Seoul (KR); Donghoon Lee, Seoul (KR)

(73) Assignee: NeublaKorea Corporation, Seoul (KR)

(21) Appl. No.: 18/588,711

(22) Filed: Feb. 27, 2024

(30) Foreign Application Priority Data
Feb. 26, 2024 (KR) 10-2024-0027213

(51) Int. Cl. G06F 9/38; G06F 12/0875

(52) U.S. Cl. CPC G06F 9/3802; G06F 12/0875; G06F 2212/452

(57) ABSTRACT

A computer system includes a processor including an instruction cache and an on-chip memory coupled to the instruction cache, and a main memory connected to the processor through a bus and loading instructions and data of the artificial intelligence model from storage of the computer system, wherein the processor is configured to: fetch an instruction block including at least some of the instructions of the artificial intelligence model loaded into the main memory to the on-chip memory when executing the artificial intelligence model; fetch at least some of the instructions included in the fetched instruction block from the on-chip memory to the instruction cache and execute the fetched instructions; check, when a next instruction of a currently executed instruction does not exist in the instruction cache, whether the next instruction exists in the on-chip memory; and fetch the next instruction from the on-chip memory to the instruction cache based on a check result.

### CROSS-REFERENCE TO RELATED APPLICATION

This application claims the benefit of Korean Patent Application No. 10-2024-0027213, filed on Feb. 26, 2024, in the Korean Intellectual Property Office, the disclosure of which is incorporated herein in its entirety by reference.

### BACKGROUND

### 1. Field

One or more embodiments relate to a method for minimizing performance degradation due to memory traffic delay when executing an artificial intelligence model and a computer system that performs the method.

This work was supported by Institute of Information & communications Technology Planning & Evaluation (IITP) grant funded by the Korea government (MSIT) (No.RS-2023-00277060, Development of open edge AI SoC hardware and software platform).

### 2. Description of the Related Art

Recently, as a field of application of artificial intelligence technology has rapidly expanded, functions and accuracy required for artificial intelligence models (artificial neural network model, etc.) are increasing. Accordingly, the size and computational amount of artificial intelligence models are rapidly increasing, and the demand for a computer system performance to process them smoothly is also increasing.

A processing performance of a computer system may typically include a computing performance (computing speed) of a processor (a central processing unit (CPU), etc.) and a memory performance (speed or bandwidth). Among these, the memory performance is not sufficiently improved compared to the computing performance of the processor, and as a result, there is a problem of increasing processing time or cost for large-scale artificial intelligence models (e.g., large language model (LLM), etc.).

### SUMMARY

One or more embodiments include a method to improve a processing performance of a computer system for an artificial intelligence model.

According to an aspect of the disclosure, a computer system includes a processor including an instruction cache and an on-chip memory coupled to the instruction cache, and a main memory connected to the processor through a bus and loading instructions and data of the artificial intelligence model from storage of the computer system, wherein the processor is configured to: fetch an instruction block including at least some of the instructions of the artificial intelligence model loaded into the main memory to the on-chip memory when executing the artificial intelligence model; fetch at least some of the instructions included in the fetched instruction block from the on-chip memory to the instruction cache and execute the fetched instructions; check, when a next instruction of a currently executed instruction does not exist in the instruction cache, whether the next instruction exists in the on-chip memory; and fetch the next instruction from the on-chip memory to the instruction cache based on a check result.

According to an exemplary embodiment, the processor adjusts a first address related to an instruction included in the fetched instruction block to a second address in the on-chip memory, and provides the adjusted second address to a program counter.

According to an exemplary embodiment, the first address is an address included in the main memory, and the processor further comprises an address adjuster adjusting the first address to the second address.

According to an exemplary embodiment, the address adjuster adjusts the first address to the second address based on a base register storing a base address of the on-chip memory.

According to an exemplary embodiment, the processor, when the second address for the next instruction is included in an address range of the instruction block fetched to the on-chip memory, fetches the next instruction stored in the second address from the on-chip memory to the instruction cache.

According to an exemplary embodiment, the processor, when the second address is not included in the address range of the instruction block fetched to the on-chip memory, fetches a new instruction block including the next instruction from the main memory to the on-chip memory, and fetches the next instruction fetched to the on-chip memory to the instruction cache.

According to an exemplary embodiment, the processor adjusts a first address corresponding to a target address of a branch instruction from among instructions included in the fetched instruction block to the second address in the on-chip memory.

According to an exemplary embodiment, the processor performs a process for fetching the next instruction from the on-chip memory to the instruction cache and a process for fetching data required for execution of the instructions from the main memory to the on-chip memory in parallel.

According to an exemplary embodiment, the processor transmits a direct memory access (DMA) request for fetching the instruction block including at least some of the instructions of the artificial intelligence model loaded into the on-chip memory to a DMA controller.

According to an aspect of the disclosure, a method of minimizing memory traffic delay when executing an artificial intelligence model of a computer system comprises fetching an instruction block including at least some of instructions of the artificial intelligence model loaded into a main memory to an on-chip memory in a processor when executing the artificial intelligence model; fetching at least some of the instructions included in the fetched instruction block from the on-chip memory to an instruction cache and execute the fetched instructions; checking, when a next instruction of a currently executed instruction does not exist in the instruction cache, whether the next instruction exists in the on-chip memory; and fetching the next instruction from the on-chip memory to the instruction cache based on a result of the checking.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic view of a computer system to which an embodiment is applied;

FIG. 2 is a view illustrating in more detail an example of a configuration of a processor shown in FIG. 1;

FIGS. 3 and 4 are views for explaining conventional memory traffic when executing an artificial intelligence model;

FIG. 5 is an exemplary view illustrating instructions and data flow of an artificial intelligence model;

FIGS. 6 to 8 are views for explaining memory traffic when executing an artificial intelligence model of a computer system, according to an embodiment; and

FIG. 9 is a flowchart to explain a method of minimizing memory traffic delay when executing an artificial intelligence model.

### DETAILED DESCRIPTION

Embodiments according to the inventive concept are provided to more completely explain the inventive concept to one of ordinary skill in the art, and the following embodiments may be modified in various other forms and the scope of the inventive concept is not limited to the following embodiments. Rather, these embodiments are provided so that the disclosure will be thorough and complete, and will fully convey the scope of the inventive concept to one of ordinary skill in the art.

It will be understood that, although the terms first, second, etc. may be used herein to describe various members, regions, layers, sections, and/or components, these members, regions, layers, sections, and/or components should not be limited by these terms. These terms do not denote any order, quantity, or importance, but rather are only used to distinguish one component, region, layer, and/or section from another component, region, layer, and/or section. Thus, a first member, component, region, layer, or section discussed below could be termed a second member, component, region, layer, or section without departing from the teachings of embodiments. For example, as long as within the scope of this disclosure, a first component may be named as a second component, and a second component may be named as a first component.

Unless otherwise defined, all terms (including technical and scientific terms) used herein have the same meaning as commonly understood by one of ordinary skill in the art to which the disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When a certain embodiment may be implemented differently, a specific process order may be performed differently from the described order. For example, two consecutively described processes may be performed substantially at the same time or performed in an order opposite to the described order.

The terms “unit”, “device”, “˜er (˜or)”, “module”, etc., refer to a processing unit of at least one function or operation, which may be implemented by hardware such as a processor, a microprocessor, an application processor, a micro controller, a central processing unit (CPU), an application processor (AP), a graphics processing unit (GPU), an accelerate processor unit (APU), a digital signal processor (DSP), an application specific integrated circuit (ASIC), a field programmable gate array (FPGA), a neural processing unit (NPU), a neuromorphic processor, etc., software, or a combination of hardware and software, and may be implemented in a form combined with a memory that stores data necessary for processing at least one function or operation.

Throughout the specification, components may be discriminated by their major functions. For example, two or more components as herein used may be combined into one, or a single component may be subdivided into two or more sub-components according to subdivided functions. Each of the components may perform its major function and further perform part or all of a function served by another component. In this way, part of a major function served by each component may be dedicated and performed by another component.

As used herein, the term “and/or” includes any and all combinations of one or more of the associated listed items.

Hereinafter, embodiments of the inventive concept will be described in detail with reference to the accompanying drawings.

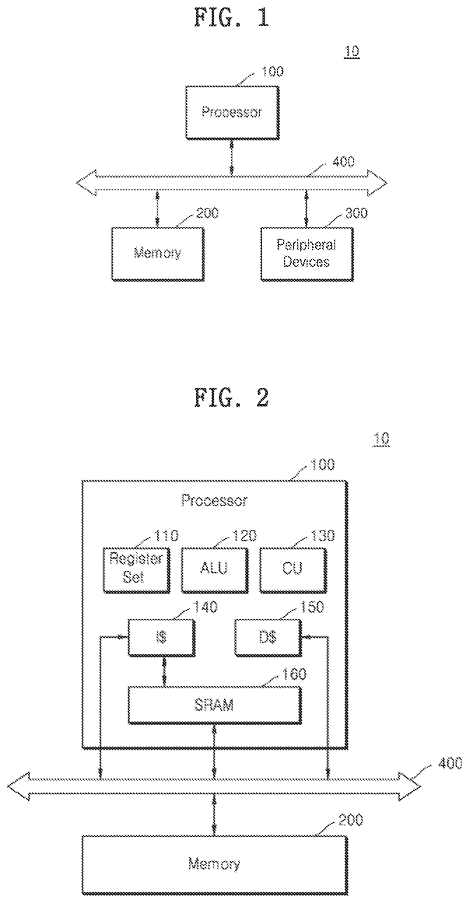

FIG. 1 is a schematic view of a computer system to which an embodiment is applied.

Referring to FIG. 1, a computer system 10 may correspond to various devices such as PCs, laptops, servers, and mobile terminals (smartphone, tablet PC, wearable device, etc.). This computer system 10 may be implemented including hardware such as a processor 100, a memory 200, and peripheral devices 300. The processor 100, memory 200, and peripheral devices 300 are connected to each other through a bus 400 and may transmit and receive signals or data.

The processor 100 may control a general operation of the computer system 10. For example, the processor 100 may execute a program by fetching instructions and data of a program from the memory 200 and processing them. In particular, the processor 100 according to an embodiment may execute an artificial intelligence model and perform various operations included in the artificial intelligence model. Executing an artificial intelligence model may mean executing a program including the artificial intelligence model.

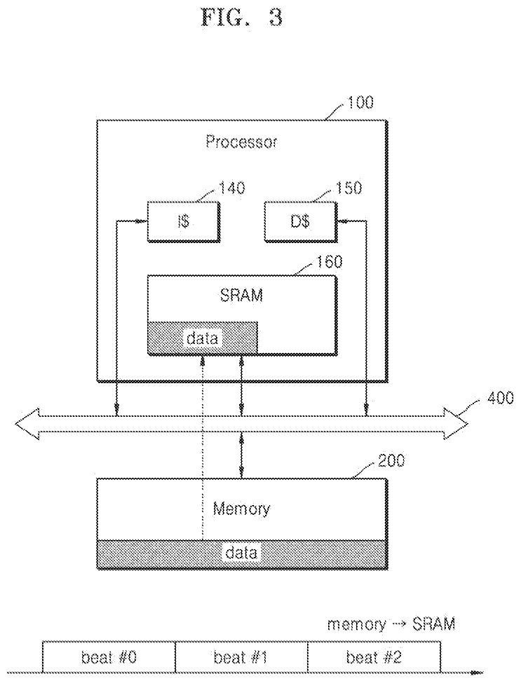

This processor 100 may include hardware such as a central processing unit (CPU), an application processor (AP), an application specific integrated circuit (ASIC), a field programmable gate array (FPGA), a graphic processing unit (GPU), and/or a neural processing unit (NPU). A configuration of the processor 100 according to an embodiment will be described in more detail later with reference to FIG. 2.

The memory 200 may store instructions and data necessary for the processor 100 to perform operations according to execution of a certain program. According to an embodiment, the memory 200 may load instructions and data for executing the artificial intelligence model from storage of the peripheral devices 300 according to the execution of the artificial intelligence model. The memory 200 may include dynamic random access memory (DRAM) as a main memory of the computer system 10, but is not limited thereto and may include various volatile memories configured between the processor 100 and the storage of the peripheral devices 300.

The peripheral devices 300 may include devices connected to a computer and controlled by the processor 100, such as storage (auxiliary storage devices such as SSD, HDD, etc.), input/output devices, and communication interfaces. For example, before the execution of the artificial intelligence model, instructions and data of the artificial intelligence model are stored in storage, and as the artificial intelligence model is executed, the instructions and data may be loaded from the storage to the memory 200. When the execution of the artificial intelligence model is completed, the storage may receive and store data generated or changed according to the execution of the artificial intelligence model from the memory 200.

FIG. 2 is a view illustrating in more detail an example of a configuration of the processor shown in FIG. 1.

Referring to FIG. 2, the processor 100 may include a register set 110, an arithmetic logic unit (ALU) 120, a control unit (CU) 130, an instruction cache 140, a data cache 150, and static random access memory (SRAM) 160. The configurations shown in FIG. 2 are an embodiment for convenience of explanation, and the types of configurations included in the processor 100 are not necessarily limited thereto. The configurations shown in FIG. 2 may be included in a core of the processor 100. That is, in FIG. 2, for convenience of explanation, the processor 100 is shown as including one core, but the processor 100 may include multiple cores. In this case, the configurations shown in FIG. 2 may also be multiple corresponding to the number of cores.

The register set 110 corresponds to a high-speed storage device that temporarily stores a small amount of data or intermediate results being processed for a specific purpose. For example, the register set 110 may include, but is limited to, a program counter (PC), an accumulator (AC), an instruction register (IR), a status register (SR), a memory address register (MAR), and a memory buffer register (MBR). Each of the registers described above is a configuration already widely known in the technical field, and detailed descriptions of each will not be given herein.

The ALU 120 may process instructions by receiving instructions from the CU 130 and performing actual operations such as arithmetic, logic, and bit operations. The CU 130 may interpret the instructions and generate a control signal that causes the ALU 120 to perform an operation based on an interpretation result. In addition, the CU 130 may manage data flow between the processor 100 and the memory 200.

The instruction cache 140 and the data cache 150 are included to minimize performance degradation due to a speed difference between the processor 100 and the memory 200. For example, in a general processor 100, the instruction cache 140 and data cache 150 may correspond to an L1 cache. The instruction cache 140 may store instructions to be executed next by the processor 100, and the data cache 150 may store data that the processor 100 frequently accesses. The instruction cache 140 and data cache 150 may be implemented with SRAM, but are not limited thereto.

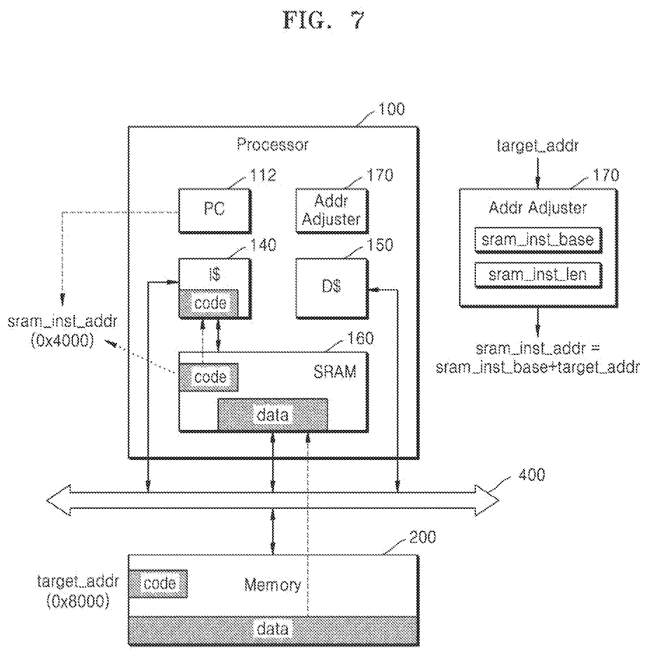

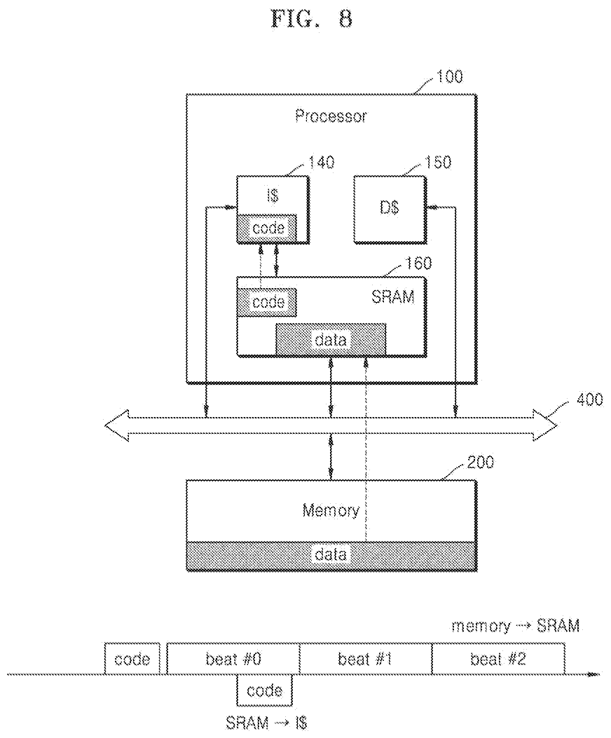

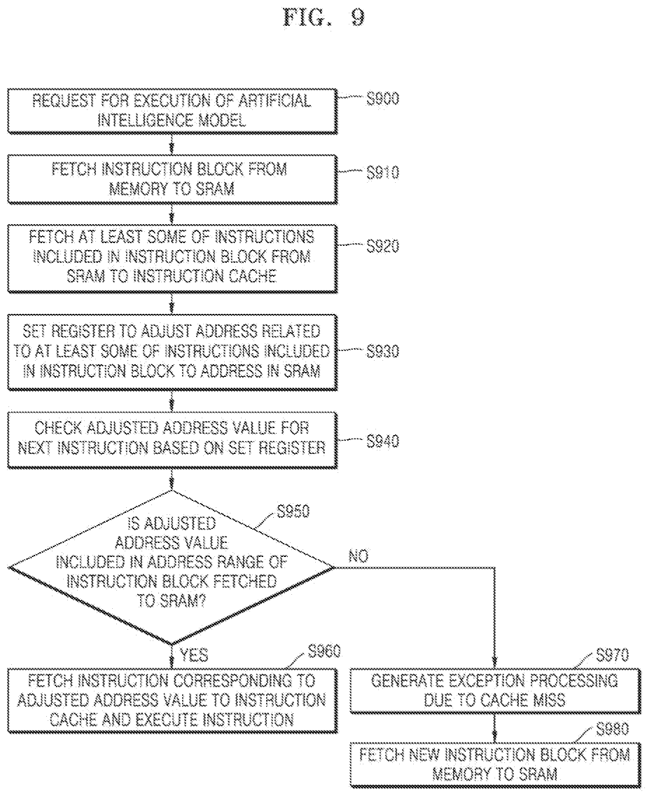

According to an embodiment, when executing an artificial intelligence model, the processor 100 may fetch an instruction block from the SRAM 160, which will be described later, to the instruction cache 140, without fetching an instruction block from the memory 200 to the instruction cache 140. Accordingly, when a cache miss occurs, data traffic degradation due to a new instruction block being fetched from the memory 200 to the instruction cache 140 may be resolved. This will be explained in more detail later with reference to FIGS. 6 to 9.

The SRAM 160 corresponds to a memory implemented separately from the instruction cache 140 and the data cache 150. In this specification, this configuration is referred to as SRAM for convenience of explanation, but the SRAM 160 may be understood as an on-chip memory implemented within the processor 100. The on-chip memory may be implemented in the processor 100, which is mainly included in large computers (servers, etc.). According to an embodiment, the SRAM 160 may fetch and store instructions and data related to an artificial intelligence model from the memory 200 when the artificial intelligence model is executed.

According to an embodiment, the SRAM 160 may include a scratchpad memory. The scratchpad memory is a software-controlled memory that, unlike a cache memory, may be accessed through an address, so a developer or compiler may write or compile program code to access the address of the scratchpad memory based on a system memory map of the computer system 10.

Hereinafter, before explaining a method of minimizing memory traffic delay when executing an artificial intelligence model according to an embodiment, a memory traffic delay phenomenon that occurs when executing a conventional artificial intelligence model will be briefly explained.

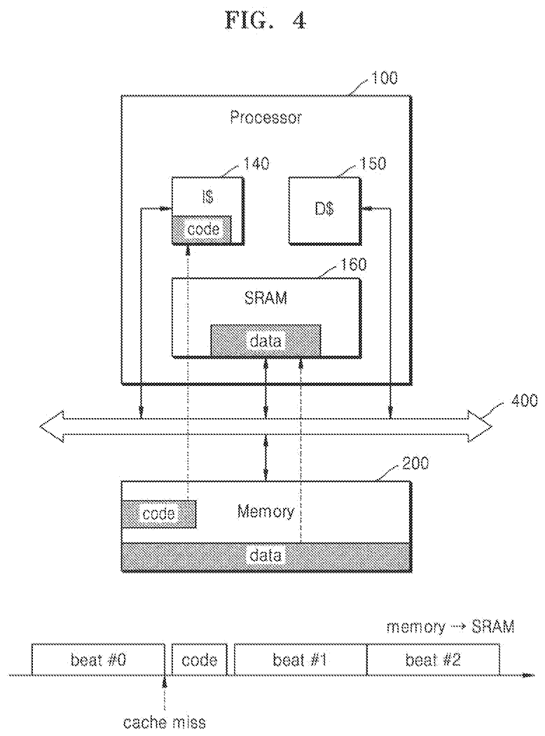

FIGS. 3 and 4 are views for explaining conventional memory traffic when executing an artificial intelligence model.

Referring to FIGS. 3 and 4, as an artificial intelligence model is executed, instructions and data of the artificial intelligence model may be loaded from storage to the memory 200. Although not shown, because the instruction cache 140 is empty when the artificial intelligence model is executed, the processor 100 may fetch some of instruction blocks stored in the memory 200 to the instruction cache 140.

For example, an instruction block fetched to the instruction cache 140 may include instructions having a plurality of consecutive addresses, and this is to reduce the probability of a cache miss by using the locality of a program. The locality may include spatial locality and temporal locality. The spatial locality is a characteristic that increases the likelihood that instructions stored in adjacent addresses will be executed consecutively, and in the case of instructions, spatial locality may be relatively high. The temporal locality is a characteristic that increases the likelihood that the content of a recently referenced address will be referenced again, and in the case of data, temporal locality may be relatively high.

The processor 100 (CU 130) may interpret instructions included in an instruction block fetched from the instruction cache 140, and identify operations and necessary data for execution (processing) of the interpreted instructions (or identify an address where the data is stored). The processor 100 may fetch data necessary for executing the instructions from the memory 200 to the SRAM 160 and perform an arithmetic process using the fetched data. At this time, the computer system 10 may perform the arithmetic process of the processor 100 and an access (fetching, etc.) process of the memory 200 in parallel. For example, when an operation according to execution of a specific instruction is performed, data fetching for execution of the next instruction may be performed in parallel. However, because the speed of the memory 200 is relatively slow compared to an operation speed of the processor 100, the processor 100 needs to wait until data fetching for execution of the next instruction is completed after an operation for a specific instruction is completed. Therefore, in order to maximize the performance of the computer system 10, it is desirable to minimize data traffic due to data fetching from the memory 200.

Recently, as artificial intelligence models have become larger, the amount of data required for operations is rapidly increasing. On the other hand, because a bandwidth of the memory 200 and the bus 400 of the computer system 10 is limited, in order to maximize the speed when fetching data, it is desirable to fetch data as continuously as possible through data requests of the longest length while maximizing the use of the bandwidth. For example, looking at burst memory transaction of an AMBA bus, because 16 to 256 burst beats, each consisting of 8 bits to 1024 bits of data, may be consecutive, data may be continuously fetched through these burst beats.

However, in the conventional case, when the next instruction exists in the instruction cache 140 after execution of a specific instruction (cache hit), the next instruction may be executed without fetching the next instruction. However, for example, in situations where an address of the next instruction to be executed is not certain, such as a conditional branch instruction, or the last instruction of an instruction block fetched to the instruction cache 140 is executed, the next instruction may not exist in the instruction cache 140 (cache miss). In this case, the processor 100 needs to fetch a new instruction block from the memory 200 to the instruction cache 140 to execute the next instruction. That is, because data fetching (data traffic) may be interrupted due to instruction fetching (instruction traffic), or a bandwidth of the bus 400 or the memory 200 used for data fetching may be reduced, a problem may occur where data traffic and memory traffic including it are degraded.

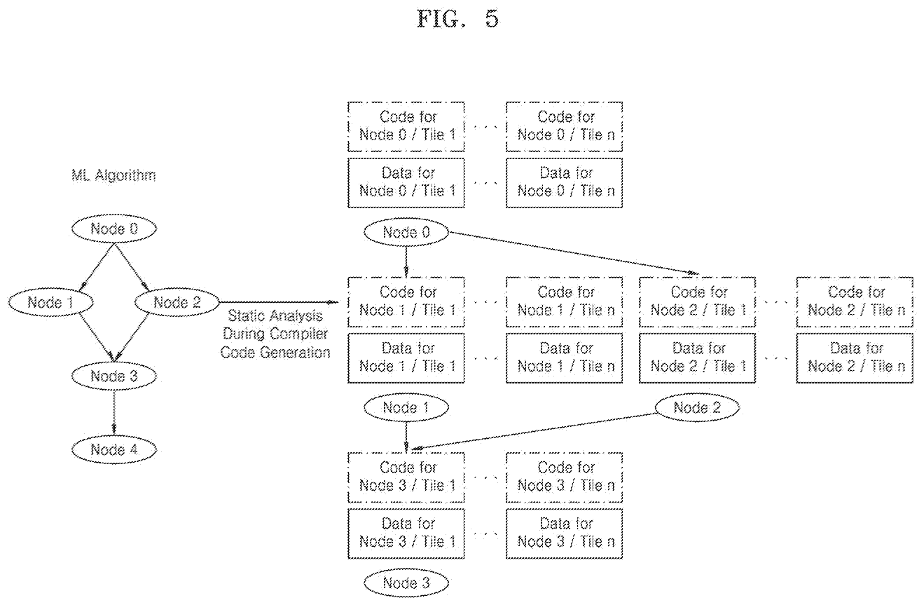

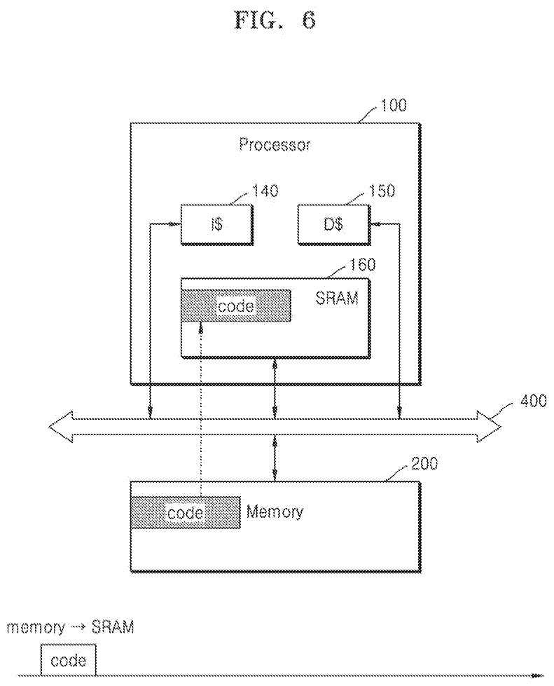

A memory traffic minimization method according to an embodiment minimizes the occurrence of cache misses when executing an artificial intelligence model and minimizes the degradation of data traffic even when a cache miss occurs, thereby enabling maximization of memory performance from among computing performance and memory performance, which are major measures of computer performance. Hereinafter, embodiments will be described in detail through FIGS. 5 to 9.

FIG. 5 is an exemplary view illustrating instructions and data flow of an artificial intelligence model. FIGS. 6 to 8 are views for explaining memory traffic when executing an artificial intelligence model of a computer system, according to an embodiment.

As described above, cache misses in the instruction cache 140 may mainly occur due to instructions that degrade program locality. For example, the instructions that degrade program locality may include conditional branch instructions in which an address of the next instruction to be executed is not certain, such as if-then-else, branch (bne, beq), etc. In particular, in the case of a general program with instructions that change a control flow of a program, such as the if-then-else described above, it is virtually impossible to accurately predict when each instruction is executed, so it is very difficult to suppress the occurrence of a cache miss.

On the other hand, referring to FIG. 5, an artificial intelligence model may be generally expressed in the form of a data flow diagram or data flow graph, which consists of a plurality of nodes and an edge connecting two different nodes. Because an artificial intelligence model implemented in the form of such a data flow graph does not include conditional branch instructions such as if-then-else or branch (bne, beq) described above, it is possible to accurately predict when all instructions are executed by appropriately utilizing a scheduling algorithm.

Based on this, referring to FIGS. 6 to 8, when executing an artificial intelligence model, the processor 100 may not fetch an instruction block from the memory 200 to the instruction cache 140, but may fetch an instruction block from the memory 200 to the SRAM 160 and then fetch instructions from the SRAM 160 to the instruction cache 140.

The instructions included in the instruction block fetched from the SRAM 160 may be instructions corresponding to an execution flow predicted based on a data flow of the artificial intelligence model, as described above. Because the SRAM 160 has a larger capacity than that of the instruction cache 140, the processor 100 may increase the size of an instruction block to maximally include instructions corresponding to the predicted execution flow. Accordingly, the instruction cache 140 may fetch some of the instructions of the instruction block fetched from the SRAM 160. According to an embodiment, the processor 100 may fetch a plurality of instruction blocks from the memory 200 to the SRAM 160, and the instruction cache 140 may fetch at least one of the plurality of fetched instruction blocks.

According to an embodiment, an instruction block fetch process from the memory 200 to the SRAM 160 may be performed by a direct memory access (DMA) controller (not shown) included in the computer system 10. In this case, the processor 100 may transmit a DMA instruction (or request) including information necessary for fetching an instruction block, such as the size and address of an instruction block to be fetched and an address of a destination (the SRAM 160), to the DMA controller. The DMA controller may fetch an instruction block corresponding to the DMA instruction from the memory 200 to the SRAM 160.

When the instruction block is fetched from the memory 200 to the SRAM 160, the processor 100 may preferentially determine whether the next instruction to be executed exists in the SRAM 160 when a cache miss occurs in the instruction cache 140.

To this end, the processor 100 may adjust an address in the memory 200 where the next instruction is stored to an address (sram_inst_addr) in the SRAM 160 and provide the address to a PC 112. According to an embodiment, the processor 100 may further include an address adjuster 170 that adjusts the address in the memory 200 to the address (sram_inst_addr) in the SRAM 160 and provides the address to the PC 112. For example, the address adjuster 170 may obtain the address (sram_inst_addr) of the SRAM 160 based on a base register that stores a base address (sram_inst_base) of the SRAM 160.

According to an embodiment, the address adjuster 170 may adjust a target address (target_addr; having an address value in the memory 200) of a branch instruction such as branch, jump, or call to the address (sram_inst_addr) in the SRAM 160.

In addition, the address adjuster 170 may check whether the next instruction exists in the SRAM 160 using a register that stores a length (sram_inst_len) of the instruction block fetched to the SRAM 160. For example, when the address (sram_inst_addr) in the SRAM 160 of the next instruction is greater than or equal to the base address (sram_inst_addr) of the SRAM 160 and is less than a sum of the base address (sram_inst_addr) and the length (sram_inst_len) of the instruction block, the next instruction may be recognized as existing in the SRAM 160. In this case, the processor 100 may prevent data traffic degradation between the memory 200 and the SRAM 160 due to a cache miss of the instruction cache 140 by fetching a new instruction block including the next instruction from the SRAM 160 to the instruction cache 140.

On the other hand, when the address (sram_inst_addr) in the SRAM 160 of the next instruction is less than the base address (sram_inst_addr) of the SRAM 160 or is greater than a sum of the base address (sram_inst_addr) and the length (sram_inst_len) of the instruction block, it can be recognized that the next instruction does not exist in the SRAM 160. In this case, the processor 100 may generate an exception due to a cache miss and fetch a new instruction block from the memory 200 to the SRAM 160. When a new instruction block is fetched to the SRAM 160, the processor 100 may fetch the new instruction block to the instruction cache 140. In other words, because the processor 100 fetches a new instruction block from the memory 200 to the SRAM 160 only when the next instruction does not exist in the SRAM 160, the frequency of affecting data traffic may be drastically reduced.

According to an embodiment, when executing an artificial intelligence model, the computer system 10 may be implemented to prefetch an instruction block from the memory 200 to the SRAM 160 and to fetch the instruction block from the SRAM 160 to the instruction cache 140. Accordingly, interference with data traffic between the memory 200 and SRAM 160 is minimized, thereby maximizing data traffic performance. As a result, memory traffic delay may be minimized and the performance of the computer system 10 may be improved.

FIG. 9 is a flowchart to explain a method of minimizing memory traffic delay when executing an artificial intelligence model.

Referring to FIG. 9, in response to a request for execution of an artificial intelligence model in operation S900, in operation S910, the computer system 10 may fetch an instruction block related to execution of the artificial intelligence model from the memory 200 to the SRAM 160.

In operation S920, the computer system 10 may fetch at least some of instructions included in the instruction block fetched to the SRAM 160 to the instruction cache 140.

In operation S930, the computer system 10 may set a register to adjust an address related to at least some of the instructions included in the instruction block to an address in the SRAM 160. For example, the adjusted address may include a target address of a branch instruction (branch, jump, call, etc.), and according to an embodiment, may also include an address indicating a location where each instruction is stored.

In operation S940, when the next instruction does not exist in the instruction cache 140, the computer system 10 may check an adjusted address value for the next instruction based on the set register.

When the adjusted address value is included in an address range of the instruction block fetched to the SRAM 160 (YES in operation S950), in operation S960, the computer system 10 may fetch an instruction corresponding to the adjusted address value to the instruction cache 140 and execute the instruction.

That is, because the computer system 10 may first check whether an instruction corresponding to the target address exists in the SRAM 160 when a cache miss occurs in the instruction cache 140 and may fetch the instruction from the SRAM 160 and process the instruction, data fetch from the memory 200 to the SRAM 160 may not be interrupted.

However, when the adjusted address value is outside the address range of the instruction block fetched to the SRAM 160 (NO in S950), in operation S970, the computer system 10 may generate exception processing due to a cache miss, and in operation S980, fetch a new instruction block from the memory 200 to the SRAM 160. Thereafter, according to operation S920, at least some of instructions included in the new instruction block may be fetched from the SRAM 160 to the instruction cache 140 and executed.

According to the technical idea of the disclosure, a computer system may minimize memory traffic degradation due to the occurrence of a cache miss by predicting an execution flow of instructions in advance using characteristics of an artificial intelligence model and fetching an instruction block based on a prediction result.

In addition, when executing an artificial intelligence model, the computer system may be implemented to prefetch an instruction block from a memory into an on-chip memory (scratchpad memory, SRAM, etc.) and to fetch the instruction block from the on-chip memory to an instruction cache. Accordingly, interference with data traffic between the memory and the on-chip memory is minimized, thereby maximizing data traffic performance. As a result, memory traffic delay may be minimized and the performance of the computer system may be improved.

Effects obtainable by the inventive concept are not limited to the effects described above, and other effects not described herein may be clearly understood by one of ordinary skill in the art to which the disclosure belongs from the above description.

While the disclosure has been particularly shown and described with reference to embodiments thereof, it will be understood that various changes in form and details may be made therein without departing from the spirit and scope of the following claims.

In addition, it will be apparent to one of ordinary skill in the art that various changes and modifications are possible within a range that does not deviate from the basic principles of the disclosure.

What is claimed is:

1. A computer system executing an artificial intelligence model, the computer system comprising:
a processor comprising an instruction cache and an on-chip memory coupled to the instruction cache; and
a main memory connected to the processor through a bus and loading instructions and data of the artificial intelligence model from storage of the computer system,
wherein the processor is configured to:
fetch an instruction block including at least some of the instructions of the artificial intelligence model loaded into the main memory to the on-chip memory when executing the artificial intelligence model;
fetch at least some of the instructions included in the fetched instruction block from the on-chip memory to the instruction cache and execute the fetched instructions;
check, when a next instruction of a currently executed instruction does not exist in the instruction cache, whether the next instruction exists in the on-chip memory; and
fetch the next instruction from the on-chip memory to the instruction cache based on a check result.

2. The computer system of claim 1, wherein the processor adjusts a first address related to an instruction included in the fetched instruction block to a second address in the on-chip memory, and
provides the adjusted second address to a program counter.

3. The computer system of claim 2, wherein the first address is an address included in the main memory, and
the processor further comprises an address adjuster adjusting the first address to the second address.

4. The computer system of claim 3, wherein the address adjuster adjusts the first address to the second address based on a base register storing a base address of the on-chip memory.

5. The computer system of claim 2, wherein the processor, when the second address for the next instruction is included in an address range of the instruction block fetched to the on-chip memory, fetches the next instruction stored in the second address from the on-chip memory to the instruction cache.

6. The computer system of claim 5, wherein the processor, when the second address is not included in the address range of the instruction block fetched to the on-chip memory, fetches a new instruction block including the next instruction from the main memory to the on-chip memory, and
fetches the next instruction fetched to the on-chip memory to the instruction cache.

7. The computer system of claim 2, wherein the processor adjusts a first address corresponding to a target address of a branch instruction from among instructions included in the fetched instruction block to the second address in the on-chip memory.

8. The computer system of claim 1, wherein the processor performs a process for fetching the next instruction from the on-chip memory to the instruction cache and a process for fetching data required for execution of the instructions from the main memory to the on-chip memory in parallel.

9. The computer system of claim 1, wherein the processor transmits a direct memory access (DMA) request for fetching the instruction block including at least some of the instructions of the artificial intelligence model loaded into the on-chip memory to a DMA controller.

10. A method of minimizing memory traffic delay when executing an artificial intelligence model of a computer system, the method comprising:
fetching an instruction block including at least some of instructions of the artificial intelligence model loaded into a main memory to an on-chip memory in a processor when executing the artificial intelligence model;
fetching at least some of the instructions included in the fetched instruction block from the on-chip memory to an instruction cache and execute the fetched instructions;
checking, when a next instruction of a currently executed instruction does not exist in the instruction cache, whether the next instruction exists in the on-chip memory; and
fetching the next instruction from the on-chip memory to the instruction cache based on a result of the checking.

11. The method of claim 10, wherein the checking of whether the next instruction exists in the on-chip memory comprises:
adjusting a first address related to an instruction included in the fetched instruction block to a second address in the on-chip memory; and
checking whether the next instruction exists in the on-chip memory based on the adjusted second address.

12. The method of claim 11, wherein the first address is an address included in the main memory, and
the adjusting comprises:
adjusting the first address to the second address based on a base address of the on-chip memory.

13. The method of claim 11, wherein the fetching of the next instruction from the on-chip memory to the instruction cache comprises:
when the second address for the next instruction is included in an address range of the instruction block fetched to the on-chip memory, fetching the next instruction stored in the second address from the on-chip memory to the instruction cache.

14. The method of claim 13, wherein the fetching of the next instruction from the on-chip memory to the instruction cache comprises:
when the second address for the next instruction is not included in the address range of the instruction block fetched to the on-chip memory, fetching a new instruction block including the next instruction from the main memory to the on-chip memory; and
fetching the next instruction fetched to the on-chip memory to the instruction cache.

15. The method of claim 10, wherein the fetching of the next instruction from the on-chip memory to the instruction cache is performed in parallel with fetching data required for execution of the instructions of the artificial intelligence model from the main memory to the on-chip memory.
